(19) United States
(12) Patent Application Publication
(10) Pub. No.: US 2010/0011244 A1
(43) Pub. Date: Jan. 14, 2010

(54) METHOD OF ROUTING DATA IN A NETWORK COMPRISING NODES ORGANIZED INTO CLUSTERS

(75) Inventors: Tinku Mohamed-Rasheed, Trento (IT); Laurent Reynaud, Trevou-Treguignec (FR); Pakistan Usman, Newbury (GB)

Correspondence Address: WESTMAN CHAMPLIN & KELLY, P.A., SUITE 1400, 900 SECOND AVENUE SOUTH, MINNEAPOLIS, MN, 55402, US

(73) Assignee: France Telecom, Paris (FR)

(21) Appl. No.: 12/439,635

(22) PCT Filed: Aug. 28, 2007
(86) PCT No.: PCT/FR07/51847

§ 371 Date: Mar. 2, 2009

(30) Foreign Application Priority Data
Aug. 30, 2006 (FR) 0607635

(51) Int. Cl. G06F 15/16; G06F 11/14

(52) U.S. Cl. 714/18; 709/241; 714/E11.113

(57) ABSTRACT

A method relates to routing data in a network, between source nodes and destination nodes pertaining respectively to distinct source groups and destination groups. The network includes intermediate groups forming at least two potential data transmission paths through which the data can be transmitted. The method includes a determination step, for each group of nodes of the network, including feedback by the nodes of the information group for determination of a quality level, representing quality of the data transmission through this group, and a step of selecting at least one transmission path from among the potential paths, for the transmission of data between the source nodes and destination nodes through the selected transmission path. The selection is made based on the quality levels of the intermediate groups of the network.

### CROSS-REFERENCE TO RELATED APPLICATIONS

This Application is a Section 371 National Stage Application of International Application No. PCT/FR2007/051847, filed Aug. 28, 2007 and published as WO 2008/025925 on Mar. 6, 2008, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to a method of routing data in a network comprising nodes organized into clusters.

### BACKGROUND OF THE DISCLOSURE

In order to facilitate the routing of data in a network, especially if that network includes a large number of nodes, it is known to organize the nodes of the network into groups known as “clusters”.

Organizing the nodes of a network into clusters is particularly necessary in a multi-hop ad hoc mobile network, that is to say a network that includes no predetermined infrastructure and in which there is moreover only a limited bandwidth and the nodes are potentially mobile.

In such multi-hop networks, data sent by a source node to a destination node passes in transit from node to node. Thus the nodes are responsible for managing the streams of data.

In a large-scale ad hoc network, that is to say an ad hoc network including a large number of nodes, for example more than 100 nodes, in order to guarantee good data transmission quality and to ensure the integrity of the data arriving at its destination, it is necessary to provide a method of routing data between the source and destination nodes that is adapted to the constraints of such ad hoc networks.

There is already known in prior art networks that include nodes organized into clusters and intermediate clusters forming at least two potential data transmission paths via which the data can be transmitted, a method of routing data between a source node and destination node belonging to respective separate source and destination clusters.

Below, the expression “potential transmission path” refers to a set of intermediate clusters through which data could be sent to a destination node. That one of potential paths via which the data is actually transmitted is referred to as the “transmission path”.

Moreover, the expression “adjacent nodes” refers to two nodes able to communicate with each other without using an intermediate node.

In order to choose a transmission path from amongst the potential paths, the prior art method generally provides for taking account of parameters such as the quality of transmission between adjacent nodes via which the data is transmitted and the quality of the nodes themselves, typically by estimating the delay and the bit rate of transmission between two nodes. However, it is difficult to estimate these parameters reliably for all nodes of a large-scale ad hoc network.

### SUMMARY

An aspect of the disclosure relates to a routing method that ensures good data transmission quality efficiently and reliably, even in a large-scale ad hoc network.

To this end, the subject matter of an illustrative embodiment of the invention is a method of routing data in a network including nodes organized into clusters, between source and destination nodes belonging to respective separate source and destination clusters, the network including intermediate clusters forming at least two potential data transmission paths over which the data could be transmitted, the method being characterized in that it includes:
a quality level determination step for each cluster of nodes of the network, in which the nodes of the cluster send back information for determining the quality level representing the quality of transmission of data via that cluster; and
a step of choosing at least one transmission path from the potential paths, with a view to transmitting data between the source and destination nodes via the chosen transmission path, the choice being made as a function of the quality levels of the intermediate clusters of the network.

When choosing a transmission path, considering the general quality of the clusters, rather than the quality of all the nodes of the network, simplifies the routing process because the number of clusters taken into account when choosing a path is considerably smaller than the number of network nodes that are taken into account in the prior art.

Thus, by means of an embodiment of the invention, it is possible to optimize transmission quality in a simple and effective manner, for example by giving priority for sending data via clusters with the best quality levels.

Note also that the complexity of the method is independent of the size of the network, since the quality level of a cluster depends only on that cluster, and not on the extent of the network.

A routing method of an embodiment of the invention can further include one or more of the following features.
Defining a cluster “adjacent” another cluster a cluster that includes at least one node adjacent a node of the other cluster, the choice step is effected locally by a local cluster through which the data is transmitted, this step including choosing the cluster with the best quality level from a number of clusters adjacent the local cluster through which the data could be transmitted. The first local cluster is the source cluster. Data is then sent progressively, each chosen cluster becoming in turn the local cluster, so that the data is transmitted iteratively. Thus an intermediate cluster is chosen simply by comparing the quality levels of clusters adjacent the local cluster. A method conforming to this implementation of the invention is particularly simply to implement.
The method includes a step of each cluster broadcasting information including its quality level to its adjacent clusters. Thus each local cluster knows the quality levels of its adjacent clusters, which assists choosing the intermediate cluster via which the data is to be sent.
The method includes a step of the source node sending the destination node a routing request and a step of the destination node responding, the response including the quality levels of all the intermediate clusters through which the response is transmitted and the quality levels of their adjacent clusters. Thus the source node obtains information for choosing the transmission path.
The choice step is effected globally so as to choose a transmission path from all the potential paths in one operation, giving preference to the clusters with the best quality levels. Thus it is possible to choose an optimum path enabling the best possible transmission quality to be obtained.
The method includes a step of each cluster broadcasting to all the other clusters of the network its quality level, a local topology table including information concerning the location of the nodes within the cluster, and a partial global topology table including information concerning the locations of the clusters adjacent that cluster. Accordingly, at the end of this broadcast step, the source cluster knows the quality levels of potential intermediate clusters, which assists with choosing the optimum transmission path via which the data is to be sent. Note that this step can be repeated at least once, and preferably regularly, so that each node keeps the local and partial global topology tables up to date.
The method includes a preliminary step of electing a master node for each cluster from amongst the nodes of the cluster, the master node being adapted to organize and maintain the cluster of nodes of which it is part, in particular by serving as a gateway between that cluster and the other nodes of the network. Electing master nodes simplifies organizing the nodes of the network into clusters. Each master node represents the cluster of which it is part to the other master nodes, the master nodes communicating with each other to update the topology tables and to provide the source node with a transmission path between that source node and a destination node situated in another cluster.
The step of determining the quality level of each cluster includes a calculation taking into account at least one parameter chosen from a connectivity parameter of the cluster, constituting a measure of the connections between the cluster and the rest of the network, a load parameter of the cluster, depending on the number of packets sent or transmitted by the nodes of the cluster during a predetermined time period, a stability parameter of the cluster, depending on the number of failures to transmit via this cluster during a predetermined time period, and a size parameter of the cluster, depending on the number of nodes of the cluster.
The step of determining quality levels is repeated at least once, for example it is repeated periodically. This is because, an ad hoc network generally evolves over time because of the mobility of its nodes, so it is preferable to update the quality levels of the clusters regularly.
In the event of a break in transmission, the cluster in which the break occurs searches for a new path to the destination node by iterating a step whereby the node in which the break in transmission to the destination node occurred sends a routing request and a step whereby the destination node responds, the response including the quality levels of all the intermediate clusters through which the response is transmitted and the quality levels of their adjacent clusters. This assists reliable transmission of the data to the destination.

Another subject matter of an embodiment of the invention is a network of nodes organized into clusters, the network being characterized in that it includes, for each cluster, means for determining a quality level representing the quality of transmission of data via that cluster, based on information sent back by the nodes of the cluster, and means for choosing an intermediate cluster as a function of the quality levels of the clusters of the network with a view to transmitting the data between the source node and the destination node via the chosen intermediate cluster.

An embodiment of the invention further relates to a cluster of nodes, the cluster being characterized in that, defining a cluster “adjacent” said cluster as a cluster that includes at least one node adjacent at least one node of said cluster, said cluster includes:
means for determining a quality level representing the quality of transmission of data via said cluster, based on information sent back by the nodes of the cluster;
means for choosing an adjacent cluster with a view to transmitting data to that adjacent cluster, these means being adapted to choose from a plurality of clusters adjacent the cluster a cluster with the best quality level.

An embodiment of the invention consists finally in a computer program characterized in that it includes software instructions stored on a computer-readable medium for executing a routing method as defined above.

### BRIEF DESCRIPTION OF THE DRAWINGS

One or more embodiments of the invention can be better understood on reading the following description, given by way of example only and with reference to the appended drawings, in which:

FIG. 1 represents a network of nodes of an embodiment of the invention;

FIG. 2 represents the steps of a routing method used in the FIG. 1 network in a first implementation of the invention; and

FIG. 3 represents the steps of a routing method used in the FIG. 1 network in a second implementation of the invention.

### DETAILED DESCRIPTION OF ILLUSTRATIVE EMBODIMENTS

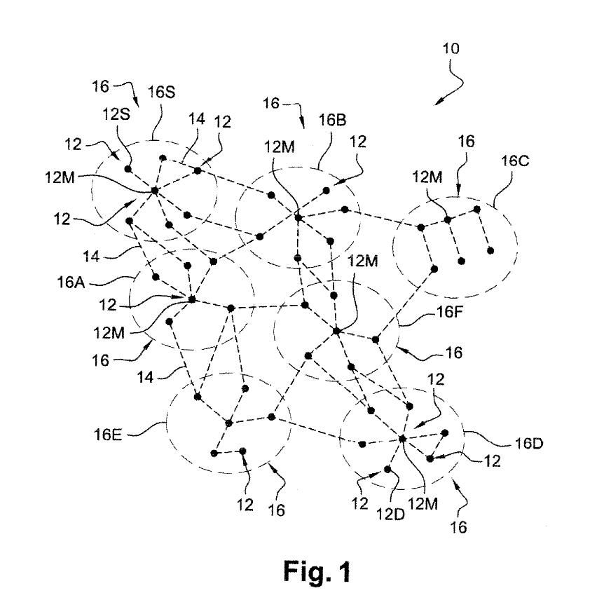

FIG. 1 represents a network 10 of nodes, for example an ad hoc network.

The network 10 includes potentially mobile nodes 12, 12M, 12S, 12D interconnected by connections 14.

In the example represented, the nodes 12 are wireless devices communicating with each other using radio waves, electromagnetic waves, or acoustic waves (such as ultrasound), and sharing a common broadcast channel. For example, the nodes 12 can be mobile terminals such as laptop computers, personal digital assistants (PDA), mobile telephones, etc.

The connections 14 are generally cables in a standard cable network or virtual connections such as radio connections in a wireless network such as an ad hoc mobile network. In a wireless network, a connection 14 between two nodes indicates that one of the nodes is in the coverage area of the other node, and therefore that the one node can send data to the other node.

The nodes 12 are conventionally organized into clusters 16, 16S, 16D, 16A, 16B, 16C, 16F. Each cluster 16 includes a node that is referred to as the master node 12M and that is intended to represent that cluster 16 in the network 10. The master node 12M is adapted to handle the organization and maintenance of the cluster of nodes of which it is part, in particular by serving as a gateway between that cluster 16 and the other nodes 12 of the network 10.

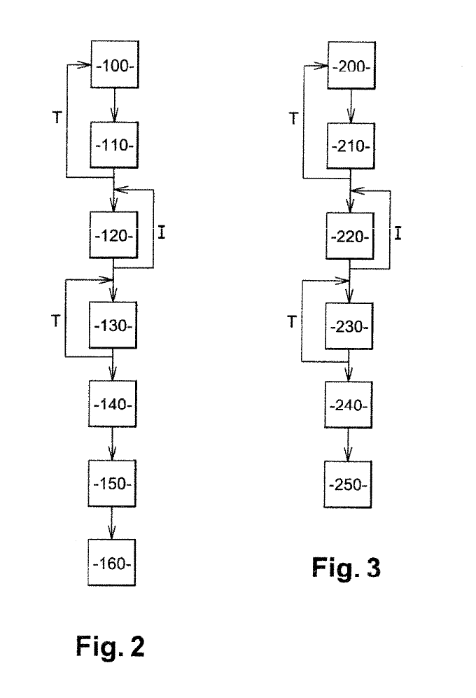

FIG. 2 shows the steps of a routing method conforming to a first implementation of the invention.

The method includes a preliminary step 100 of organizing the nodes 12 into clusters 16 and electing for each cluster 16 a master node 12M intended to represent that cluster in the network 10. This step is conventional and is usually employed to facilitate routing data in an ad hoc network.

For example, the preliminary step 100 can include the assignment to each node 12 of the network 10 of a numerical value, referred to as a weight, representing its capacity to become a master node. Each node 12 of weight greater than the weight of any of its adjacent nodes is then elected as the master node 12M of a cluster including that master node 12M and all its adjacent nodes.

Of course, the nodes 12 can be organized into clusters 16 in any other known manner. Thus the cluster 16 can include any number of nodes 12, that number depending in particular on how the step of organizing the nodes is carried out.

Once the nodes 12 have been organized into clusters 16, there follows a step 110 of establishing topological tables of the network.

During this step a local topological table is established for each cluster 16 that includes a list of all the nodes 12 of that cluster 16 and takes account of how those nodes 12 are organized in this cluster 16.

In order to establish the local topological table of a cluster 16, the master node 12M of that cluster sends a location request to all the other nodes 12 of the cluster. After receiving the request, the other nodes 12 respond by sending the master node 12M location information enabling the master node 12M to establish the local topological table.

During this same step 110, partial global topological tables are also established that include a list of the clusters adjacent the clusters 16 and that take account of how these adjacent clusters are organized relative to one another.

In order to establish the partial global topological tables, each cluster 16 initially carries out a search of its adjacent clusters, that is to say those other clusters that include at least one node adjacent one of the nodes of the cluster in question. The search can be effected in the following manner:
the master node 12M of each cluster 16 generates and broadcasts a request searching for adjacent clusters;
if a node 12 that is not part of the cluster 16, i.e. whose master node is different from that which sent the request, receives the request, that node 12 responds by sending the master node 12M a message including the identifier of its own master node and information concerning the path taken by the request, for example an identifier of the node that sent it the request;
using the responses received, the master node 12M updates a partial global topological table including the information about the location of its adjacent clusters.

By means of the local and partial global topological tables, each master node can, simply by consulting these topological cables, find out which nodes 12 are nodes of its cluster 16 and which clusters are adjacent its cluster 16.

Note that, in order to take account of the mobility of the nodes 12 of the network 10, the step 100 of organizing the nodes and the step 110 of establishing topological tables are preferably repeated regularly, for example periodically with a predetermined period T.

The routing method then includes a step 120 of determining a numerical value for each cluster 16, which numerical value, called the quality level, represents the general quality of transmission of data via this cluster 16. To this end, each master node includes means for determining a quality level.

In order to determine the quality level of each cluster 16, the master node 12M of each cluster 16 sends an information request to the other nodes 12 of that cluster 16, which nodes respond by sending back to this master node 12M information for calculating parameters that are used to determine the quality level.

The request generally also includes a numerical value corresponding to a time interval I at the end of which the nodes send the information again, to update the quality level. For example, this time interval I depends on the dynamics of the network (long in a stable network, short in a network whose nodes are particularly mobile). This time interval I is preferably equal to the period T of repetition of the steps 100 of organizing the nodes and 110 of establishing the topology.

Examples of parameters for assessing the quality of a cluster 16 are given below.

°A first possible parameter is a group connectivity parameter P_{C}, providing a measure of the connections between the cluster 16 and the rest of the network 10. This is because the greater the number of adjacent clusters that serve a given cluster 16, the more effectively it can transmit data.

The connectivity parameter P_{C} can be calculated as follows:

$${P}_{C} = \frac{{N}_{V}}{{n}_{BN}} ( {\sum }_{{N}_{V}} \frac{1}{{V}_{BN}} )$$

where:
N_{V} is the number of clusters adjacent the cluster 16;
N_{BN} is the number of boundary nodes of the cluster 16, that is to say the number of nodes of the cluster that are adjacent nodes belonging to adjacent clusters; and
V_{BN} is the number of boundary nodes of an adjacent cluster that are connected to a boundary node of the cluster 16.

°A second possible parameter is a cluster load parameter P_{CH}, depending on the number of packets sent or transmitted by the nodes 12 of the cluster 16 in a predetermined time period. A parameter of this kind gives a measure of the activity of the cluster 16. The predetermined time period is equal to the time interval I, for example.

The load parameter can be calculated as follows:

$${P}_{CH} = \frac{{\sum }_{1}^{N} {X}_{i}}{N}$$

where:
Xᵢ is the rate at which packets pass through a node i of the cluster 16 during the predetermined time period; and
N is the number of nodes of the cluster 16.

°A third possible parameter is a cluster 16 stability parameter Ps depending on the number of transmission failures via this cluster 16 during a predetermined time period, for example a time period equal to the time interval I.

The stability parameter Ps can be calculated as follows:

$${P}_{S} = \frac{{T}_{E}}{{T}_{T}}$$

where:
T_{E} is the number of transmissions that failed in the cluster during the predetermined time period;
T_{T} is the total number of transmissions effected by the cluster during the predetermined time period.

°A fourth possible parameter is a cluster 16 size parameter P_{T}, depending on the number of nodes 12 belonging to the cluster 16.

The parameters defined above are adapted to represent effectively the quality of the cluster 16, but, to calculate the quality level of a cluster, the person skilled in the art implementing an embodiment of the invention can of course take other parameters into account, in addition to or instead of one or more of the above-mentioned parameters.

The person skilled in the art also knows how to determine a formula for calculating a pertinent quality level by combining the parameters defined above, whether weighted or not.

Note that some parameters can be more or less pertinent according to the required application and the organization of the network. For example, if all the clusters 16 have substantially the same number of nodes 12, it would not be necessary to take the size parameter P_{T} into account in calculating the quality level. The person skilled in the art knows how to choose the pertinent parameters for calculating the quality level, and where applicable their weighting to be taken into account in the calculation.

At the end of the determination step 120, the quality level determined for each cluster is stored in the master node 12M of that cluster. To this end, each master node 12M is provided with means for storing the quality level.

Note that the determination step 120 is preferably repeated regularly, for example periodically with a period equal to the time interval I, in order to take account of modifications of the network caused by the mobility of the nodes 12 of the network 10.

The method then includes a step 130 of broadcasting information from each cluster 16 to its adjacent clusters, this information being transmitted from master node to master node. The information broadcast by a cluster 16 includes the quality level of that cluster 16 and its local topological table, and sometimes also its partial global topological table.

This broadcasting step 130 can be repeated regularly, for example periodically, in order to update the information if modifications are effected in the clusters (for example if a node enters or leaves a cluster). The repeat period of the broadcasting step 130 is preferably equal to the repeat period T of the steps 100 of organizing the nodes and 110 of establishing the topological table.

If a source node 12S, belonging to a source cluster 16S, has to transmit data to a destination node 12D belonging to a destination cluster 16D, there follows a step 140 of sending a routing request from this source node 12S to that destination node 12D.

During this step 140, using its local topological table, the master node 12M of the source group 16S verifies that the destination node 12D is not part of the cluster to which it belongs, since it would suffice to send it the data in the conventional way.

If the destination node 12D belongs to another cluster 16D, the master node 12M sends the routing request to its adjacent clusters in the conventional way. This routing request includes in particular respective identifiers of the source node 12S and the destination node 12D.

When a master node 12M receives the request, it verifies if the destination node 12D is part of its cluster using its local topological table.

If not, it transmits the request to its adjacent clusters, the master nodes of which iterate the same operation until the cluster 16D including the destination node 12D receives the request.

Note that, since each cluster 16 has broadcast its partial global topological table to its adjacent clusters during the step 130, they know which other clusters are adjacent the cluster 16. Thus provision can be made for a cluster not to transmit the request to the other adjacent clusters of the cluster that sent it the request, since those adjacent clusters have already received the request, at the same time as it received it itself. This prevents superfluous transmissions that would congest the network.

For example, referring to FIG. 1, the cluster 16B, after receiving the request from the source cluster 16S, transmits that request to the clusters 16C and 16F, but not to the cluster 16A because it has already received the request from the source cluster 16S. The cluster 16C does not transmit the request since its adjacent clusters 16B and 16F have already received it.

When the cluster 16D including the destination node 12D receives the request, there follows a response step 150 during which the master node 12M of that cluster 16D sends a response to the source node 12S over the path that is the inverse of that taken by the routing request.

Note that the group 16D considers only the first routing request received and ignores identical routing requests reaching it after that first request via another path.

For example, referring to FIG. 1, the request can reach the destination cluster 16D by passing through the sequence of clusters 16B, 16F or the sequence of clusters 16A, 16E or the sequence of clusters 16A, 16F. The destination cluster 16D considers only the first request received, for example that which has passed through the clusters 16B, 16F.

The response includes the identifiers of the intermediate clusters forming the transmission path the response has taken, information from the local and global partial topological tables, and information on the quality levels of each intermediate cluster. To this end, each intermediate cluster that transmits the response adds information concerning itself before sending it.

Thus the source node 12S receives information (topological tables and quality levels) concerning a potential transmission path to the destination node, in particular information concerning each cluster 16 of the transmission path and information concerning its adjacent clusters.

When the source node 12S has received the response, there follows a step 160 of that source node 12S sending the data to be transmitted to the destination node 12D.

In the first implementation of the invention, the sending step 160 also chooses a transmission path. To this end, each master node 12M includes means for choosing an intermediate cluster to form the transmission path.

The intermediate clusters forming the transmission path are chosen from the intermediate clusters forming the potential path received in the routing response and the clusters adjacent those intermediate clusters.

The path is then chosen progressively, a local cluster that has to transmit data choosing the next intermediate cluster in the following manner.

Of a series of clusters forming the potential path received in the routing response, the first cluster in the received potential path after the local cluster is not necessarily that with the best quality level for reaching the second cluster in the received potential path after the local cluster.

The cluster therefore attempts to reach that second cluster in the received potential path after the local cluster via a common adjacent cluster whose quality level is better than that of the other common adjacent clusters.

This optimizes transmission quality by choosing clusters whose quality levels are better than those of the clusters initially indicated by the potential path received in the response to the routing request.

Thus data is transmitted progressively, the first local cluster being the source cluster and each chosen intermediate cluster then becoming the local cluster, until the local cluster is adjacent the cluster including the destination node, whereupon it sends it the data directly in the conventional way. In particular, if the source and destination clusters are adjacent, the source cluster sends the data directly to the destination cluster in the conventional way.

Referring to FIG. 1, for example, where the potential path received in the routing response consists of the clusters 16B, 16F, the second cluster of the received potential path after the local cluster (currently the source cluster) 16S is the cluster 16F. The aim is to reach that cluster via an adjacent cluster common to the clusters 16S and 16F with the best quality level.

If this best common adjacent cluster is the cluster 16A, the source cluster 16S sends it the data. Thus the cluster 16A becomes the local cluster.

The second cluster in the received potential path after the local cluster 16A is then the destination cluster 16D. The aim now is to reach that cluster 16D via an adjacent cluster common to the clusters 16A and 16D with the best quality level, for example the cluster 16E.

The cluster 16A then sends the data to the cluster 16E, which becomes the local cluster.

Since this cluster 16E is adjacent the destination cluster 16D, it then sends it the data directly in the conventional way.

Note that within a cluster data is transmitted from node to node, for example giving preference to the nodes with the best transmission quality, in the conventional way.

In the event of a break in transmission, that is to say if a node that has to transmit the data is no longer available, the local cluster in which the break has occurred attempts to send the data to the destination node 12D, for example by determining a new transmission path by starting the process again as if this local cluster were a source cluster.

This first implementation of the invention has the advantage of being simple to implement, the intermediate clusters that transmit the data being chosen simply by comparing quality levels.

FIG. 3 represents the steps of a routing method conforming to a second implementation of the invention.

This method includes a preliminary step 200 of organizing the nodes 12 into clusters, a step 210 of establishing topographical tables of the network, and a step 220 of determining a quality level for each cluster of nodes of the network, these steps being similar to the steps 100, 110, and 120, respectively, of the first implementation of the invention.

However, the step 210 of establishing topological tables differs from the step 110 of the first implementation in that it further includes each cluster broadcasting its partial global topological table to all the other clusters of the network, all the partial tables obtained by each cluster in this way being used to establish a global topological table of the network accounting for the mutual organization of all the clusters 16 of the network 10.

The method then includes a step 230 of broadcasting information from each cluster 16 to all the other clusters of the network 10. Thus each cluster 16 receives global information concerning the entire network 10. Each master node then has access to a quality matrix representing the quality levels of all the clusters 16 of the network 10 and of the overall topological table of the network 10.

Then, during a step 240 of choosing a transmission path, the master node of the source cluster 16S can choose an optimum transmission path in one operation, using information obtained during the step 230 and giving preference to clusters with the best quality levels.

During a step 250, the source node sends the data to the destination node using the chosen transmission path.

Note that, within a cluster, data is transmitted from node to node, for example giving preference to the nodes with the best transmission quality, in the conventional way.

If characteristics of the network change during transmission, notably in the event of a change in the quality levels of the clusters, there can be a change, during broadcasting, to a mode of broadcasting by progressive choice similar to that used in the first implementation of the invention, based on the path chosen in the step 240.

This second implementation of the invention has the advantage of enabling the choice of an optimum transmission path with the best possible transmission quality.

Note finally that the invention is not limited to the implementations described above but encompasses any variant reproducing its essential features using equivalent means.

Although the present disclosure has been described with reference to one or more examples, workers skilled in the art will recognize that changes may be made in form and detail without departing from the scope of the disclosure and/or the appended claims.

1. A method of routing data in a network including nodes organized into clusters, between a source node and a destination node belonging to respective separate source and destination clusters, the network including intermediate clusters forming at least two potential data transmission paths over which the data could be transmitted, the method comprising:
a quality level determination step for each cluster of nodes of the network, in which the nodes of the cluster send back information for determining a quality level representing quality of transmission of data via that cluster; and
a step of choosing at least one transmission path from the potential paths, with a view to transmitting the data between the source node and the destination node via the chosen transmission path, the choice being made as a function of the quality levels of the intermediate clusters of the network

2. The method of routing data according to claim 1, wherein:
a cluster “adjacent” another cluster is defined as a cluster that includes at least one node adjacent a node of the other cluster,
the step of choosing is effected locally by a local cluster through which the data is transmitted, this step including choosing the cluster with the best quality level from a number of clusters adjacent the local cluster through which the data could be transmitted.

3. The method of routing data according claim 2, including a step of each cluster broadcasting information including its quality level to its adjacent clusters.

4. The method of routing data according to claim 2, including:
a step of the source node sending the destination node a routing request, and
a step of the destination node responding, the response including the quality levels of all the intermediate clusters through which the response is transmitted and the quality levels of their adjacent clusters.

5. The method of routing data according claim 1, wherein the step of choosing is effected globally so as to choose a transmission path from all the potential paths in one operation, giving preference to the clusters with the best quality levels.

6. The method of routing data according claim 5, including a step of each cluster broadcasting to all the other clusters of the network its quality level, a local topology table including information concerning the location of the nodes within the cluster, and a partial global topology table including information concerning the locations of the clusters adjacent that cluster.

7. The method of routing data according to claim 1, including a preliminary step of electing a master node for each cluster from amongst the nodes of the cluster, the master node being adapted to organize and maintain the cluster of nodes of which it is part, in particular by serving as a gateway between that cluster and the other nodes of the network.

8. The method of routing data according to claim 1, in which the step of determining the quality level of each cluster includes a calculation taking into account at least one of the following parameters:
a connectivity parameter P_{C} of the cluster, constituting a measure of the connections between the cluster and the rest of the network;
a load parameter P_{CH} of the cluster, depending on the number of packets sent or transmitted by the nodes of the cluster during a predetermined time period;
a stability parameter P_{S} of the cluster, depending on the number of failures to transmit via this cluster during a predetermined time period; and
a size parameter P_{T} of the cluster, depending on the number of nodes of the cluster.

9. The method of routing data according to claim 1, wherein the step of determining quality levels is repeated at least once.

10. The method of routing data according to claim 1, including, in the event of a break in the transmission of data, a new step of choosing a intermediate cluster with a view to retransmission of the data between the cluster in which the break in transmission occurred and the destination node via the chosen intermediate cluster.

11. A network of nodes organized into clusters, the network comprising, for each cluster:
means for determining a quality level representing the quality of transmission of data via that cluster, based on information sent back by the nodes of the cluster; and
means for choosing an intermediate cluster as a function of the quality levels of the clusters of the network with a view to transmitting the data between the source node and the destination node via the chosen intermediate cluster.

12. A cluster of nodes comprising:
means for determining a quality level representing the quality of transmission of data via said cluster, based on information sent back by the nodes of the cluster; and
means for choosing an adjacent cluster with a view to transmitting data to that adjacent cluster, these means being adapted to choose from a plurality of clusters adjacent the cluster a cluster with the best quality level, wherein an “adjacent” cluster is defined as a cluster that includes at least one node adjacent at least one node of said cluster.

13. A computer program including software instructions stored on a computer-readable medium for executing a method of routing data in a network including nodes organized into clusters, between a source node and a destination node belonging to respective separate source and destination clusters, the network including intermediate clusters forming at least two potential data transmission paths over which the data could be transmitted, the method comprising:
a quality level determination step for each cluster of nodes of the network, in which the nodes of the cluster send back information for determining a quality level representing quality of transmission of data via that cluster; and
a step of choosing at least one transmission path from the potential paths, with a view to transmitting the data between the source node and the destination node via the chosen transmission path, the choice being made as a function of the quality levels of the intermediate clusters of the network.
